(19) United States
(12) Patent Application Publication
(10) Pub. No.: US 2006/0232579 A1
(43) Pub. Date: Oct. 19, 2006

(54) WOA panel architecture

(75) Inventors: Ying-Lieh Chen, Tainan (TW); Biing-Seng Wu, Tainan (TW); Lin-Kai Bu, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: Himax Technologies, Inc.

(21) Appl. No.: 11/403,053

(22) Filed: Apr. 11, 2006

Related U.S. Application Data
(60) Provisional application No. 60/671,355, filed on Apr. 14, 2005.

(51) Int. Cl. G09G 5/00

(52) U.S. Cl. 345/211

(57) ABSTRACT

The present invention provides solutions to simplify and reduce the resources needed for manufacturing liquid crystal display modules. Failure of mid-process steps during mass production can result in significant costs. According to certain embodiments of the present invention, a WOA display panel architecture requires fewer LCM resources or has no PCB. Although the COG process and WOA method provide higher reliability in temporary LCD production, the costs associated with the space required for wires on the PCB or display panel for larger panel sizes remains expensive. Larger panel sizes also requires an increased number of driver ICs to construct a flat display panel. Similarly, the number of wires connecting each driver IC to a timing controller IC, gamma operational amplifier IC and DC-to-DC converter IC creates spacing problems that translate into higher production costs. These problems can be solved by certain embodiments of the present invention.

### CROSS-REFERENCE TO RELATED APPLICATION

This application claims the benefit of U.S. Provisional Application Ser. No. 60/671,355, filed Apr. 14, 2005, pursuant to 35 U.S.C. § 119(e), which application is hereby incorporated by reference.

### FIELD OF THE INVENTION

The present invention relates to a liquid crystal display (LCD) apparatus for displaying images, and in particular certain embodiments of the present invention relate to an architecture of an LCD device allowing the costs associated with liquid crystal display module (LCM) resources to be reduced.

### BACKGROUND OF THE INVENTION

Now that people are accustomed to liquid crystal display (LCD) devices, the applications of LCD are expanding, forcing the manufacture of LCD devices to become a cost effective industry. Liquid crystal display module (LCM) production includes producing a glass panel, packaging driver chips with a chip on glass (COG) process, attaching a flexible printed circuit board (FPC) to the glass, affixing a back light module to the back of the glass panel and, optionally, supporting all of the components with a metal cover. Each step of this process comprises more complex steps. For example, the COG process includes the steps of cell loading, wet cleaning, UV cleaning, integrated circuit (IC) main-binding, IC pre-binding, anisotropic conductive film (ACF) attachment, cell unloading, and visual inspection. Incautious operations may cause damage to the LCM and prevent a whole set of components from shipping. Failure in any step results in the loss of at least a whole LCM and, accordingly, lost profit.

U.S. Pat. Publication No. US2001/0013850 to Sakaguchi et al., entitled “Liquid crystal display device, liquid crystal controller and video signal transmission method,” which is hereby incorporated by reference, discloses a liquid crystal device comprising liquid crystal cells on a substrate and a plurality of driver ICs applying voltages to the liquid crystal cells, wherein the ICs are cascade-connected using signal lines. The control portion of the LCD device includes a plurality of source driver ICs configured to provide voltage signals for the source terminals of the liquid crystal cells, a plurality of gate driver ICs configured to provide voltage signals for the gate terminals of the liquid crystal cells, an LCD controller configured to receive video signals and control signals from an external computer or controlling hardware and to transmit display signals to driver ICs, and a DC-to-DC converter configured to supply specific voltages to driver ICs for triggering the liquid crystal cells. This publication further discloses a method to lessen the total number of video signals, thereby reducing manufacturing costs. However, the cost to assemble the components, (e.g. source ICs, gate ICs, DC-to-DC converters and LCD controller) is still expensive. Furthermore, a printed circuit board (PCB) is necessary to connect those components.

U.S. Pat. No. 6,844,629 to Chen et al., entitled “Display panel with bypassing lines,” which is hereby incorporated by reference, provides at least one bypassing line made of FPC to bypass signals between chips mounted on the glass via the COG process. In this disclosure, a timing control chip and source driver IC chips are mounted on a PCB. The PCB transfers driving signals into the source terminals of liquid crystal cells on an LCD panel.

U.S. Pat. Publication No. US2005/0184978 to Bu et al., entitled “Signal driving system for a display,” which is hereby incorporated by reference, discloses a driving system for a display, comprising a signal controller producing a first control signal, a flexible connector connected to the signal controller and receiving the first controlling signal, a first driving device, and at least one second driving device, wherein the first driving device receives the first control signal, and passes it to the second driving device. A driving signal output port of the first driving device sends out a first data signal which is converted to a second data signal, using Transistor-Transistor Logic (TTL) signals. Although the conversion of the data signals provides the appropriate communication between driving devices, a flexible connector, (e.g. an FPC) is still necessary for connecting the signal controller to the first driving device. Moreover, a PCB is needed to host the signal controller. The level of resources required for such an LCM is high.

FIG. 1 is a diagram showing a traditional architecture for an LCD apparatus. This traditional architecture comprises a display panel 17, a plurality of gate driver ICs (G/D) 110 mounted on the display panel 17 by a COG process, a plurality of FPCs 15 connected to the display panel 17, a plurality of source driver ICs (S/D) 16 packaged on the FPCs 15 using a tape carrier package (TCP) method, a PCB 11 connected to the FPCs 15, a DC-to-DC converter IC (DC-DC) 12, a gamma operational amplifier IC (Gamma OP) 13, and a timing controller IC (TCON) 14 bonded on the PCB 11 wherein at least one of the FPCs 15 supplies power and control signals to the gate driver ICs (G/D) 110 through a power line 18 and a control signal line 19 fabricated on the display panel 17. The timing controller IC (TCON) 14 provides video and clock signals via metal lines formed on the PCB 11 and further transmits the signals into the source driver ICs (S/C) 16, via the metal lines formed on the PCB 11 and conductive lines formed on the FPCs 15. The timing controller IC (TCON) 14 also provides data/control signals via metal lines formed on the PCB 11 and transmits the data/control signals to the source driver ICs (S/C) 16 via the metal lines formed on the PCB 11 and conductive lines formed on the FPCs 15. The FPCs 15 connect, via the power line 18 and control signal line 19, with the gate driver ICs (G/D) 110.

The gamma operational amplifier IC (Gamma OP) 13 provides gamma correction voltages to the FPCs 15, and provides reference voltages to the source driver ICs (S/D) 16. The source driver ICs (S/D) 16 use the reference voltages to drive the liquid crystal cells on the display panel 17, resulting in images that are easier on the eye.

The DC-to-DC converter IC (DC-DC) 12 supplies specific voltages to the source driver ICs (S/D) 16, gate driver ICs (G/D) 110, and gamma operational amplifier IC (Gamma OP) 13. The DC-to-DC converter IC (DC-DC) 12 can also provide regulated power to the timing controller IC (TCON) 14 to eliminate a regulator IC. Typically a higher voltage is required to drive this display panel 17 then is used by the other logic devices. For example, the timing controller IC (TCON) 14 may require a lower voltage of 1-5V, while the display panel may require a higher voltage of 30-40V.

The source driver ICs (S/D) 16 provide image data to the display panel 17. The gate driver ICs (G/D) 110 act as scanning devices, sending scanning signals to the gate terminals of the liquid crystal cells, e.g. Thin Film Transistors (TFT). Since the scanning function of the gate driver ICs (G/D) 110 is comparatively simple, the control signals 19 for the gate driver ICs (G/D) 110 are fewer compared to the data and control signals for the source driver ICs (S/D) 16. There are often more than 20 data and control signals per source driver IC 16.

FIG. 2 illustrates another traditional architecture for an LCD apparatus. This traditional architecture comprises a display panel 27, a plurality of gate driver ICs (G/D) 2101-2103 mounted on the display panel 27 by the COG process, an FPC 25 connected to the display panel 27, and a plurality of source driver ICs (S/D) 261-265 packaged directly on the display panel 27, e.g., also using a COG process. The LCD architecture of FIG. 2 also includes a PCB 21 connected to the FPC 25. The PCB 21 comprises a DC-to-DC converter IC (DC-DC) 22, a gamma operational amplifier IC (Gamma OP) 23 and a timing controller IC (TCON) 24 bonded on the PCB 21.

The FPC 25 supplies power and control signals to the gate driver ICs (G/D) 2101-2103 and the source driver ICs (S/D) 261-265 via wiring-on-array (WOA) technology. The FPC 25 further provides a power line 28 connecting the first source driver IC (S/D) 261 to the second source driver IC (S/D) 262. Similarly, the power line 28 connects the second driver IC 262 to the first gate driver IC (G/D) 2101. Power lines 28 also connect the first gate driver IC (G/D) 2101 to the second gate driver IC (G/D) 2102, and the second gate driver IC (G/D) 2102 to the third gate driver IC (G/D) 2103. Likewise, the control signals 29 for the gate driver ICs (G/D) 2101-2103 are provided by the FPC 25 and pass through the first source driver IC (S/D) 261, the second source driver IC (S/D) 262, and then the first, second, and third gate driver ICs (G/D) 2101-2103, as illustrated.

Another power line 28 connects the third source driver IC (S/D) 263, the fourth source driver IC (S/D) 264 and then the fifth source driver IC (S/D) 265. The data/control signals 211 for the source driver ICs (S/D) 261-265 are divided into two branches. The first branch of data/control signals 211 is connected to the first source driver IC (S/D) 261 and then to the second source driver IC (S/D) 262. The second branch of data/control signals 211 is connected to the third source driver IC (S/D) 263 and then to the fourth and fifth source driver ICs (S/D) 264 and 265.

The timing controller IC (TCON) 24 provides video and clock signals to the metal lines on the PCB 21 and further transmits signals on the metal lines of the FPC 25 and the WOA lines of the panel 27 to the source driver ICs (S/D) 261-265. The timing controller IC (TCON) 24 provides data/control signals on the metal lines of the PCB 21 and transmits data/control signals via the metal lines of the FPC 25, which connects to the power line 28 and control signal line 29, to the gate driver ICs (G/D) 2101-2103.

The gamma operational amplifier IC (Gamma OP) 23 provides gamma correction voltages into metal lines on the PCB 21 that are connected to the FPC 25 and to the source driver ICs (S/D) 261-265. The gamma correction voltages act as reference voltages for driving the liquid crystal cells of the display panel 27, resulting in images that are easier on the eye.

### SUMMARY OF THE INVENTION

Certain embodiments of the present invention utilize WOA technology, which eliminates the cost of FPCs. The size of the PCB can be reduced due to the omission of the connection area for the FPCs, the reduction in size being proportional to the number of source driver ICs. The PCB also avoids a transmission of large numbers of signals to the source driver ICs. The reduction of components requires a lower level of resources for LCM production compared to the architecture employing the TCP technology in the prior art.

Certain embodiments of the present invention allow a reduction in the cost of maintaining LCM manufacturing resources, resulting from the ability to omit certain spare parts that might otherwise be necessary. This can also increase yield and profit.

According to one embodiment of the present invention, a WOA panel architecture comprises a display panel, a plurality of gate driver ICs, a plurality of source driver ICs, two integrated chips mounted on the display panel, an FPC coupling a PCB with the display panel, a DC-to-DC converter IC, and a gamma operational amplifier IC mounted on the PCB, wherein each of the integrated chips performs the functions of both a source driver IC and a timing controller IC.

According to certain aspects of the present invention, in order to minimize LCM resource requirements, a WOA panel architecture comprises a display panel, a plurality of gate driver ICs, a plurality of integrated chips mounted on the display panel, an FPC coupling a PCB with the display panel, a DC-to-DC converter IC, and a gamma operational amplifier IC mounted on the PCB, wherein each of the integrated chips performs the functions of both a source driver IC and a timing controller IC. For example, the timing controller function can be integrated into the source driver IC.

According to certain aspects of the present invention, a WOA panel architecture comprises a timing controller IC without an embedded chip. Said WOA panel architecture comprises a display panel, a plurality of gate driver ICs, a plurality of source driver ICs, a timing controller IC mounted on the display panel, an FPC coupling a PCB with the display panel, and a gamma operational amplifier IC mounted on the PCB, wherein the timing controller IC is bonded using a COG process. For example, gold bump pads are grown on the normal pads of the timing controller IC and pressed on the WOA lines or pads of the display panel with a layer ACF material. The gamma operational amplifier IC can also be mounted on the display panel using the same method. In addition, the DC-to-DC converter IC can be mounted on the panel with the COG process.

According to certain embodiments of the present invention, a WOA panel architecture comprises a display panel, a plurality of gate driver ICs, a plurality of integrated chips mounted on the display panel, an FPC coupling a PCB with the display panel, and a DC-to-DC converter IC mounted on the PCB wherein each integrated chip integrates the functions of a source driver IC, a timing controller IC, and a gamma operational amplifier IC. Here, the functions of a timing controller IC and a gamma operational amplifier IC are integrated into the source driver IC. For further simplifying the LCM components, the DC-to-DC converter IC can be integrated into the source driver IC using a SOC (system on chip) method.

### BRIEF DESCRIPTION OF THE DRAWINGS

Various objects and advantages of the present invention will be more readily understood from the following detailed description when read in conjunction with the appended drawings, in which:

FIG. 1 is a diagram showing a traditional architecture for an LCD apparatus;

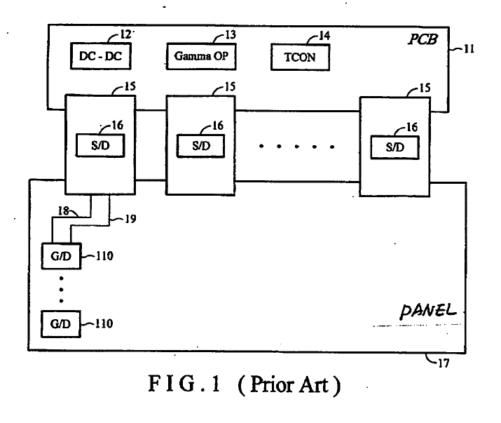

FIG. 2 is a diagram showing another traditional architecture for an LCD apparatus that uses WOA;

FIG. 3 is a diagram showing a WOA panel architecture according to certain embodiments of the present invention;

FIG. 4 is a diagram showing a WOA panel architecture according to certain embodiments of the present invention;

FIG. 5 is a diagram of a WOA panel architecture according to certain embodiments of the present invention, in which the LCM components comprise fewer types of driver ICs;

FIG. 6 is a diagram of a WOA panel architecture according to certain embodiments of the present invention, in which simplified WOA lines are used to save space on the display panel;

FIG. 7 is a diagram of a WOA panel architecture according to certain embodiments of the present invention, comprising simplified LCM components to reduce total cost;

FIG. 8 is a diagram of a WOA panel architecture according to certain embodiments of the present invention, comprising a gamma operational amplifier IC on glass to further simplify the LCM components and reduce total cost;

FIG. 9 is a diagram of a WOA panel architecture according to certain embodiments of the present invention, comprising a DC-to-DC converter IC on glass to further simplify the LCM components and the total cost;

FIG. 10A is a diagram of a WOA panel architecture according to certain embodiments of the present invention;

FIG. 11A is a diagram of a WOA panel architecture according to certain embodiments of the present invention;

FIG. 12A is a diagram of a WOA panel architecture according to certain embodiments of the present invention; and

FIG. 13A is a diagram of a WOA panel architecture according to certain embodiments of the present invention.

### DESCRIPTION OF EMBODIMENTS OF THE INVENTION

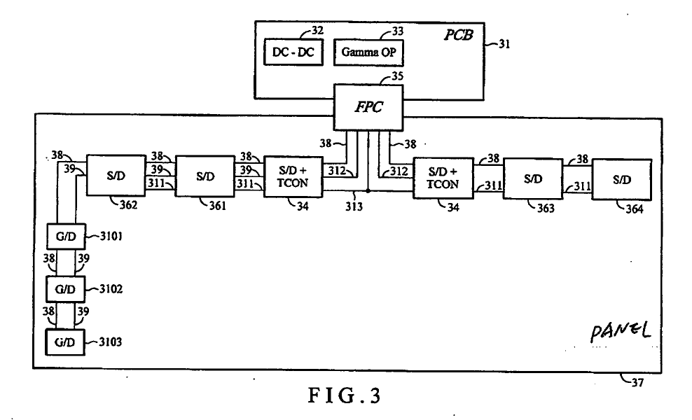

FIG. 3 illustrates a wiring-on-array (“WOA”) panel architecture according to certain embodiments of the present invention. The panel architecture, comprises a display panel 37, a PCB 31 coupling the display panel 37 with an FPC 35, a PCB 31 comprising a DC-to-DC converter IC (DC-DC) 32 to provide power, and a gamma operational amplifier IC (Gamma OP) 33 to provide gamma reference voltage signals. The panel architecture further comprises a plurality of source driver ICs (S/D) 361-364 and a plurality of gate driver ICs (G/D) 3101-3103 mounted on the display panel 37 using a COG process, and at least one integrated chip 34 mounted on the display panel 37 that performs the functions of both a source driver IC (S/D) 361 and a timing controller.

The COG process allows a chip to be positioned directly on a display panel. This can be achieved by using gold bumps grown on the driver ICs and the use of ACF (Anisotropic Conductive Film) material. Typically, the pads on standard chips have open windows on the passivation layer, and the exposed top metal layer is made of aluminum. By adopting an additional alloy layer composed of titanium and tungsten, a gold bump can be deposited on the alloy layer having thicker structure and better conductive properties. The ACF material, comprising conductive particles dispersed in an adhesive film, functions as an electrical connection between the gold bump pads and metal pads of either the FPCs or the PCB.

The principle of ACF connection is to apply appropriate temperature and pressure over a short period of time. First, the ACF material is placed between the gold bump pads of the driver ICs and the metal pads on the substrate, e.g. the PCB, FPC, or WOA lines on the display panel. The gold bump pads of the driver ICs are aligned and pressed on the metal pads of the substrate. The resin balls of the ACF layer, which are coated with a shell of gold and nickel material, become conductive when the particles are pressed into contact with the gold bump pads and the metal pads. The gold bump pads are spaced apart such that the conductive particles do not electrically short the path between any two gold bump pads.

Another bonding technique is to use a tape carrier package (“TCP”) method to bond a chip to an FPC, PCB, or glass panel. This technique utilizes an FPC with a device hole in the center and a plurality of fingered leads floating in the air. A driver IC with gold bump pads is pressed onto the fingered leads of the FPC. Then, resin material is applied to protect the bonded structure of the driver IC and FPC.

Many manufacturers have adopted the chip-on-glass (“COG”) process because of its advantages over the TCP technique. In the COG process, the leads are fixed on the substrate and no device hole is needed. Advantages of the COG process include increased quality from the use of fixed leads, reduced costs associated with adhesive material, and higher dimensional stability from reduced lamination stress. In addition, the reduction in stress concentration associated with the flexible ACF thin film allows fine pitch patterning, resulting in smaller overall chip size.

Fabrication of an LCM module can further comprise the steps of junction implementation and module assembly. The junction implementation process comprises the COG process, attachment of the FPC, attachment of the PCB, testing of the PCB, and applying silicone material to protect the whole electrical module. The module assembly process comprises the steps of backlight assembly, assembly testing, aging tests, final inspection, and packing. Each such step contains many parts. For example, the backlight assembly includes a light guide, a reflector, a lamp cover, a lamp reflector, a lamp holder, etc. Each level of testing also decreases the production yield. The COG process can reduce both chip size and stress during packaging. This process can improve production yield for liquid crystal modules and reduce the LCM resources required.

Referring again to FIG. 3, integrated chips 34, which can perform the functions of both a source driver IC (S/D) 361 and a timing controller, receive control and data signals 313 (e.g., red data, green data, blue data, clock, a horizontal synchronization signal and a vertical synchronization signal) from a graphics IC or graphics card, and output control and data signals 311 to source driver ICs (S/D) 361-364. Integrated chips 34 additionally output control signals 39 to gate driver ICs (G/D) 3101-3103, optionally though source driver ICs (S/D) 361, 362, via WOA lines. The control and data signals 311 of the source driver ICs (S/D) 361-364 comprise data signals related to image data and control signals related to display timing.

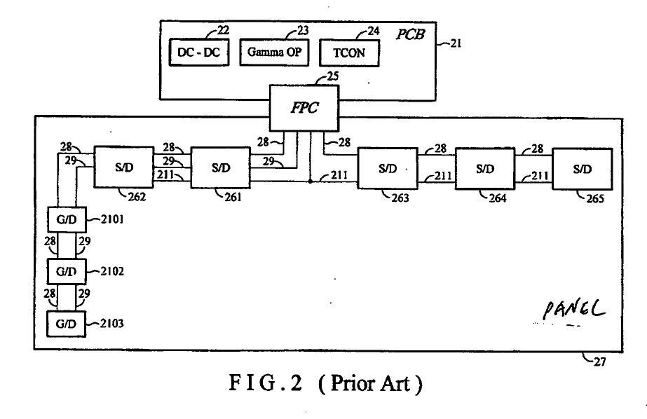

The gamma operational amplifier IC (Gamma OP) 33 generates gamma reference voltage signals 312 on certain metal lines of the PCB 31 and FPC 35 for the integrated chips 34 and the source driver ICs (S/D) 361-364. The DC-to-DC converter IC (DC-DC) 32 provides power 38 via certain metal lines of the PCB 31 and FPC 35. The power lines 38 may use WOA technology. If there is sufficient space on the display panel 37, the power lines 38 can be arranged as a single, wider connection line connecting each of the driver ICs directly with the FPC 35. Thus, the WOA panel architecture illustrated in FIG. 3 simplifies the data/control signals 211 of the source driver ICs 261-265 illustrated in FIG. 2, through the use of the integrated chips 34. The differences between the embodiment illustrated in FIG. 3 and traditional architectures become particularly significant as the panel size increases. As the number of source driver ICs increases, so does the number of control/data signals for those source driver ICs, which places spacing constraints on the PCB 31, FPC 35 and/or display panel 37. The embodiments of the present invention illustrated in FIG. 3 therefore reduce the costs associated with the PCB 31, FPC 35 and the display panel 37.

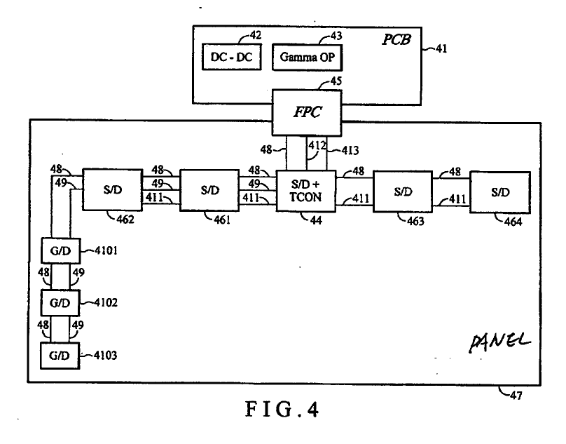

Referring to FIG. 4, a panel architecture comprises a display panel 47, a PCB 41 coupled with the display panel 47 via a FPC 45, a DC-to-DC converter IC (DC-DC) 42 mounted on the PCB 41 to provide power, and a gamma operational amplifier IC (Gamma OP) 43 mounted on the PCB 41 to provide gamma reference voltage signals. The panel architecture further comprises a plurality of source driver ICs (S/D) 461-464 and a plurality of gate driver ICs (G/D) 4101-4103 mounted on the display panel 47 by the COG process. Only one IC chip 44, which performs the functions of both a source driver IC (S/D) 461 and a timing controller, is mounted on the display panel 47. The IC chip 44 receives control and data signals 413 (e.g., red data, green data, blue data, a clock, a horizontal synchronization signal and a vertical synchronization signal) from a graphics IC or graphics card, and outputs control and data signals 411 to the source driver ICs (S/D) 461-464. The IC chip 44 further outputs control signals 49 to the gate driver ICs (G/D) 4101-4103 via WOA lines, optionally though the source driver ICs (S/D) 461, 462. The control and data signals 411 of the source driver ICs (S/D) 461-464 comprise data signals related to image data and control signals related to display timing.

The gamma operational amplifier IC (Gamma OP) 43 provides gamma reference voltage signals 412 on certain metal lines of the PCB 41 and FPC 45 for the integrated chip 44 and the source driver ICs (S/D) 461-464. The DC-to-DC converter IC (DC-DC) 42 provides power lines 48 on certain metal lines of the PCB 41 and FPC 45. By utilizing a single integrated chip 44, the signal paths from the FPC 45 to the integrated chip 44 are minimized and spacing on the display panel can be further reduced relative to FIG. 3. Shorter connections also improve the electrical properties of the integrated chip 44.

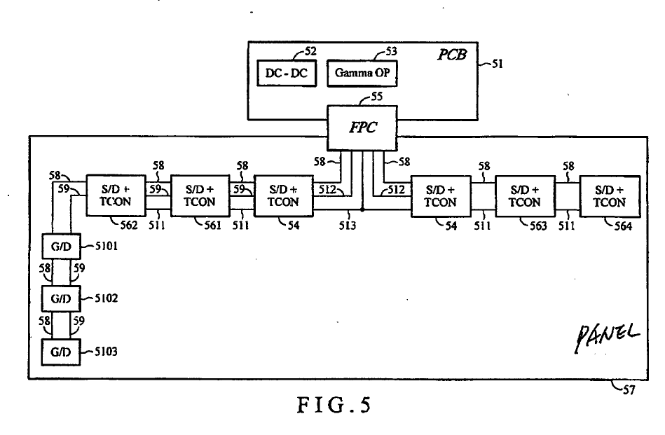

FIG. 5 illustrates a WOA panel architecture according to certain embodiments of the present invention, in which fewer types of ICs are used. The panel architecture comprises a display panel 57, a PCB 51 coupled with the display panel 57 via a FPC 55, a DC-to-DC converter IC (DC-DC) 52 to provide power, and a gamma operational amplifier IC (Gamma OP) 53 to provide gamma reference voltage signals. The DC-to-DC converter 52 and gamma operational amplifier 53 are mounted on the PCB 51.

A plurality of gate driver ICs (G/D) 5101-5103 are mounted on the display panel 57 by the COG process. A plurality of integrated chips 561-564, and 54 which perform the functions of both a source driver IC and a timing controller, are mounted on the display panel 57. The IC chips 54 receive control and data signals 513 (e.g., red data, green data, blue data, a clock, a horizontal synchronization signal and a vertical synchronization signal) from a graphics IC or graphics card, and output control and data signals 511 for cascading to chips 561-564. The IC chips 54 further output control signals 59 to gate driver ICs (G/D) 5101-5103 via WOA lines, optionally though source driver ICs (S/D) 561, 562. The control and data signals 511 of the ICs 561-564 comprise data signals related to image data and control signals related to display timing.

The gamma operational amplifier IC (Gamma OP) 53 provides the gamma reference voltage signals 512 on certain metal lines of the PCB 51 and FPC 55, for the integrated chips 54 and the source driver ICs (S/D) 561-564. The DC-to-DC converter IC (DC-DC) 52 provides regulated power on power lines 58. The control and data signals 511 can be the same as the signals 311 in FIG. 3. This embodiment further simplifies LCM resources due to the integrated chips 561-564, 54. The power lines 58 can be connected in cascade, or they can be connected directly and independently to each driver IC.

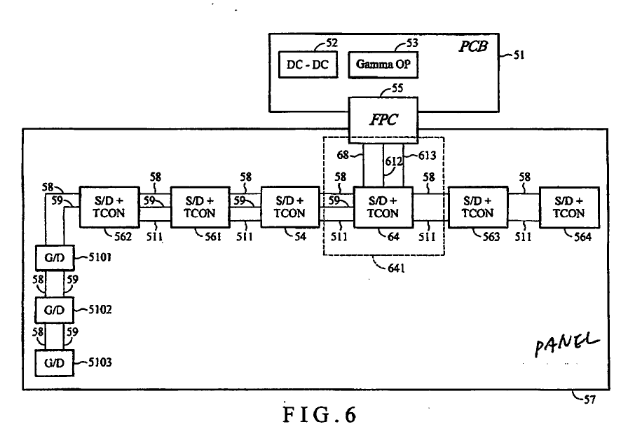

FIG. 6 illustrates a WOA panel architecture according to certain embodiments of the present invention, in which the WOA lines are further simplified, resulting in additional space savings in the display panel. The dotted box 641 highlights the differences between FIG. 6 and FIG. 5. An integrated chip 64 that performs the functions of both a source driver IC and a timing controller is mounted on the display panel 57. In this diagram, similar numbers indicate equivalent components to FIG. 5. The panel architecture comprises power lines 68, gamma reference voltage signals 612 provided by the gamma operational amplifier IC (Gamma OP) 53 via metal lines of the PCB 51 and FPC 55, control and data signals 613 (e.g., red data, green data, blue data, a clock, a horizontal synchronization signal and a vertical synchronization signal) from a graphics IC or graphics card, and an integrated chip 64 which is directly connected to the FPC 55 via the shortest path. This configuration improves the electrical connection between the PCB 51 and the chip 64. After receiving gamma reference voltage signals 612 and control and data signals 613, the chip 64 further transmits timing and data information to the other driver ICs via WOA lines.

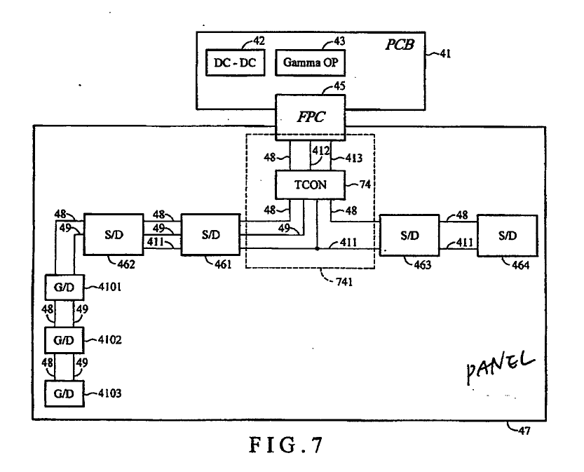

FIG. 7 illustrates a WOA panel architecture according to certain embodiments of the present invention, which further simplifies LCM resources and reduces manufacturing cost. Similar numbers to FIG. 4 represent similar elements, while differences from FIG. 4 are noted by the dotted box 741. A timing controller IC (TCON) 74, which is bonded on the display panel 47 adjacent to the FPC 45, replaces the integrated chip 44 from FIG. 4. The timing controller IC (TCON) 74 further comprises several output connections to source driver ICs (S/D) 461-464. The timing controller IC (TCON) 74 optionally receives power lines 48 from FPC 45 or the DC-to-DC converter IC (DC-DC) 42. The timing controller IC (TCON) 74 further receives gamma reference voltage signals 412 from the gamma operational amplifier IC (Gamma OP) 43, and receives control and data signals 413 from a graphics IC or graphics card via metal lines of the PCB 41 and FPC 45. After the timing controller IC (TCON) 74 processes those signals, necessary data and control signals are sent out to the driver ICs, including the source driver ICs (S/D) 461-464 and the gate driver ICs (G/D) 4101-4103, via WOA lines. This allows manufacturers to use original timing controller ICs without another integrated chip performing the functions of both a source driver IC and a timing controller IC.

The timing controller IC (TCON) 74 can be mounted on the display panel 47 by growing gold bump pads on the pads of the timing controller IC (TCON) 74 and bonding the IC (TCON) 74 directly onto the WOA lines of the display panel 47 using the COG process. Putting the timing controller IC (TCON) 74 on panel 87 can reduce the cost of the PCB 41 and FPC 45 because signal paths can be reduced compared to traditional display panel WOA architectures.

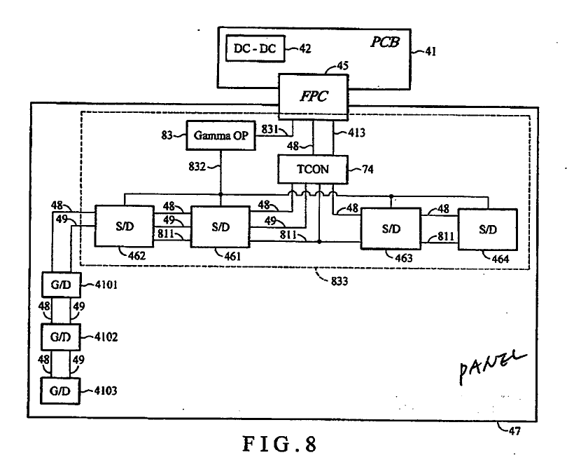

FIG. 8 illustrates a WOA panel architecture according to certain embodiments of the present invention, comprising a gamma operational amplifier IC (Gamma OP) 83 on panel 47 to further simplify LCM resources and total cost. Similar numbers to FIG. 7 represent similar elements, while differences from FIG. 7 are encircled by the dotted box 833. The gamma operational amplifier IC (Gamma OP) 83 is mounted on the panel 47 using the COG process. Mounting both the gamma operational amplifier IC (Gamma OP) 83 and the timing controller IC (TCON) 74 on the display panel 47 eliminates the gamma reference voltage signals 412 of FIG. 7. The gamma operational amplifier IC (Gamma OP) 83 outputs a plurality of gamma reference voltage signals 832 to the source driver ICs (S/D) 461-464 via WOA lines. This reduces the number of WOA lines for the output data and control signals 411, and reduces the number of WOA lines connected to the FPC 45 due to the elimination of gamma reference voltage signals 412. Voltage 831 is supplied to the gamma operational amplifier IC (Gamma OP) 83 by the DC-to-DC converter IC (DC-DC) 42 via certain metal lines of the PCB 41 and FPC 45. The control and data signals 811 contain timing signals and image data signals from the timing controller IC (TCON) 74. These changes reduce the number of wires for the FPC 45 and accordingly reduces space consumption.

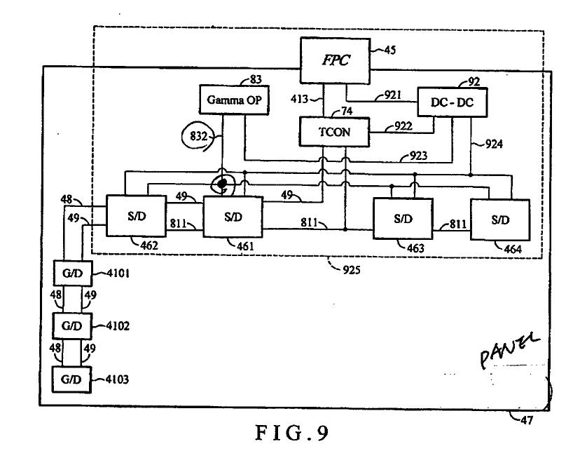

FIG. 9 illustrates a WOA panel architecture according to certain embodiments of the present invention, comprising a DC-to-DC converter IC (DC-DC) 82 on glass to further simplify LCM resources and total cost. Similar numbers to FIG. 8 represent similar elements, while differences from FIG. 8 are encircled by the dotted box 925. In this embodiment, all of the chips that were previously located on the PCB are now mounted on the display panel using the COG process, such that the PCB 41 of FIG. 8 can be completely eliminated. The number of metal wires of the FPC 45 is further decreased. By bonding the DC-to-DC converter IC (DC-DC) 92 on the panel 47 by the COG process, the FPC 45 provides only control and data signals 413 and basic DC power through a power line 921 to the DC-to-DC converter IC (DC-DC) 92.

The DC-to-DC converter IC 92 generates several DC power outputs for different purposes. A power line 922 provides normal logic power to the timing controller IC (TCON) 74, which comprises mainly logic circuits for digital signal processing. Power lines 923 provide necessary reference voltages for the gamma operational amplifier IC (Gamma OP) 83. Power lines 924 provide necessary voltages to source driver ICs (S/D) 461-464 .

Accordingly, the PCB 41 of FIG. 8 is no longer necessary. The power lines 831, 48 for (i) the gamma operational amplifier IC (Gamma OP) 83, (ii) the timing controller IC (TCON) 74 and (iii) the source driver ICs (S/D) 461-464 can be eliminated. The power lines 48 to the gate driver ICs (G/D) 4101-4103 remain, but they can alternatively be omitted by connecting the power of the gate driver ICs (G/D) 4101-4103 to the DC-to-DC converter IC (DC-DC) 92 directly, provided that there is sufficient space on the panel 47.

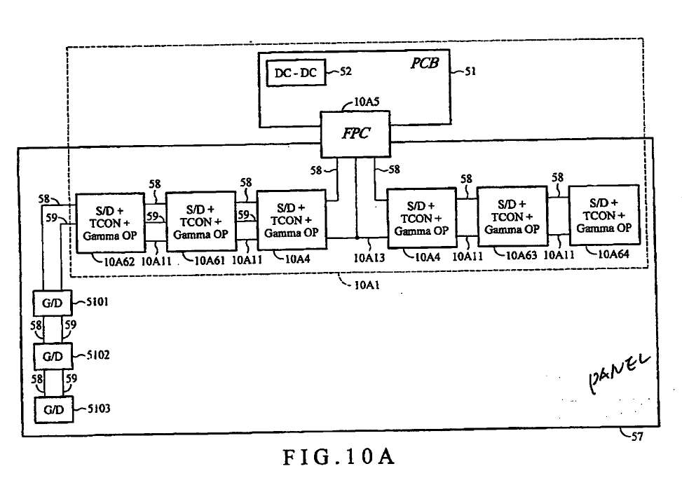

FIG. 10A illustrates a WOA panel architecture according to certain embodiments of the present invention similar to the embodiments illustrated in FIG. 5. Similar numbers to FIG. 5 represent similar elements, while differences from FIG. 5 are encircled by the dotted box 10A1. The gamma operational amplifier IC (Gamma OP) 53 of FIG. 5 is integrated into integrated chips 10A61-10A64 and 10A4 on glass to further simplify LCM resources and total cost. The functions of a source driver IC, a timing controller IC, and a gamma operational amplifier IC are all integrated into a single system-on-chip (“SOC”) chip. Accordingly, the WOA lines on the display panel 57 can be further simplified.

Because the function of a gamma operational amplifier is embedded into the integrated chips 10A61-10A64, 10A4, the gamma reference voltage signals 512 and corresponding wires can be eliminated. This allows the FPC 10A5 to be more compact and the cost of the PCB 51 to be reduced. The elimination of gamma reference voltage signals also reduces the number of control and data signals 10A11, 10A13 relative to the embodiment illustrated in FIG. 5.

The gamma reference voltage levels are generated by the embedded gamma operational amplifier of the integrated chips 10A61-10A64, 10A4. These modifications enable reduced PCB 51 costs, reduced display panel 57 costs, and simplified LCM resources as three individual chips are now integrated into one.

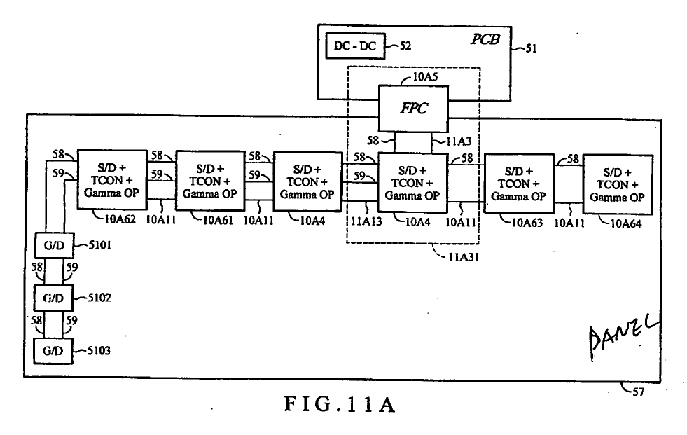

FIG. 11 A illustrates a WOA panel architecture according to certain embodiments of the present invention similar to the embodiments illustrated in FIG. 10A. Similar numbers to FIG. 10A represent similar elements, while differences from FIG. 10A are encircled by the dotted box 11A31. The FPC 10A5 is connected to a first integrated chip 10A4, providing shorter signal paths. There is one set of control and data signals 11A3 from the FPC 10A5 provided by the PCB 51 from general graphic chips or graphics cards. The second integrated chip 10A4 receives control and data signals 11A13 from the first integrated chip 10A4, which connects to the FPC 10A5. This configuration provides improved electrical properties.

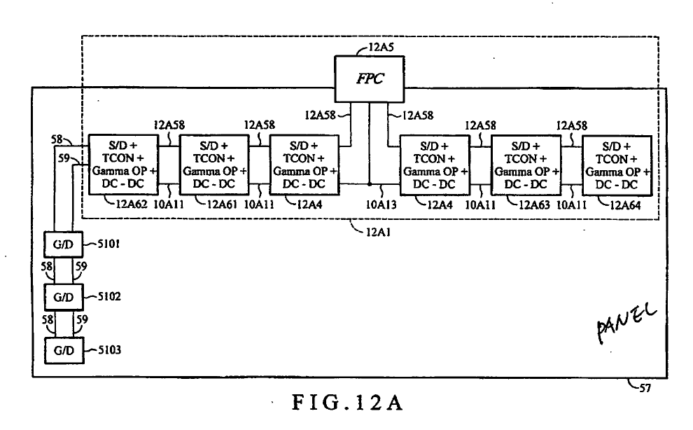

FIG. 12A illustrates a WOA panel architecture according to certain embodiments of the present invention similar to the embodiments illustrated in FIG. 10A. Similar numbers to FIG. 10A represent similar elements, while differences from FIG. 10A are encircled by the dotted box 12A1. The DC-to-DC converter IC (DC-DC) 52 of FIG. 10A is integrated into the integrated chips 12A61-12A64. Since there is not an individual DC-to-DC converter IC, the PCB 51 of FIG. 10A is eliminated. Furthermore, the omission of the PCB and the DC-to-DC converter IC can reduce the burden of the FPC 12A5 because the FPC 12A5 no longer needs to relay power lines for different applications. Instead, different voltage levels for diverse applications can be generated inside the integrated chips 12A61-12A64 themselves, simplifying the power lines 12A58 from the FPC 12A5.

The management of LCM resources is simplified due to the elimination of the single DC-to-DC converter IC and the PCB. Moreover, the control signals 59 previously (in FIG. 10A) generated by the integrated chips 10A4 can be ignored because the integrated chips 12A62 can generate these control signals 59 and transmit them to the adjacent gate driver IC (G/D) 5101 directly.

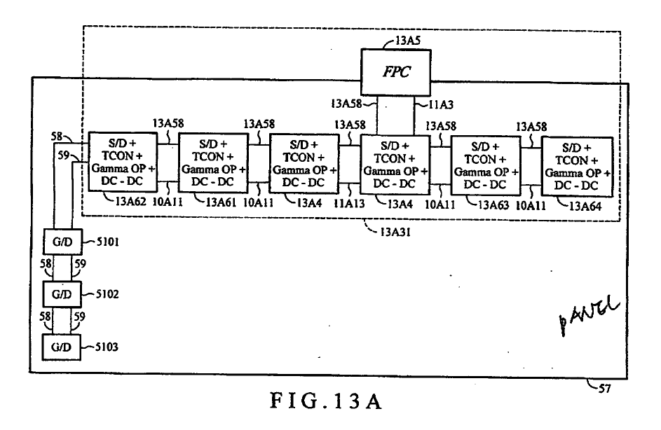

FIG. 13A illustrates a WOA panel architecture according to certain embodiments of the present invention similar to the embodiments illustrated in FIG. 11A. Similar numbers to FIG. 11A represent similar elements, while differences from FIG. 11A are encircled by the dotted box 13A31. The DC-to-DC converter IC (DC-DC) 52 of FIG. 11A is integrated into the integrated chips 13A61-13A64. Since there is not an individual DC-to-DC converter IC, the PCB 51 of FIG. 11A can be eliminated. Furthermore, the omission of the PCB and DC-to-DC converter IC can reduce the burden of the FPC 13A5 because the FPC 13A5 no longer needs to relay power lines for different applications. Instead, the voltage levels for diverse applications can be generated inside the integrated chips 13A61-13A64 themselves, simplifying the power lines 13A58 from the FPC 13A5. The management of the LCM resources is simplified due to the elimination of the single DC-to-DC converter IC and the PCB. Moreover, the control signals 59 previously (in FIG. 11A) generated by the integrated chips 110A4 can be ignored because the integrated chips 13A62 can generate these control signals 59 and transmit them to the gate driver ICs (G/D) 5101 directly.

It is to be understood that these embodiments are not meant as limitations of the invention but merely exemplary descriptions of the invention with regard to certain specific embodiments. Indeed, different adaptations may be apparent to those skilled in the art without departing from the scope of the annexed claims. For instance, each integrated chip 13A61-13A64 in FIG. 13A can have individual power lines directly from the FPC 13A5 provided there is enough spacing area on the display panel 57. The power lines 58 of the gate driver ICs (G/D) 5101-5103 in FIG. 13A can also have individual power lines directly from the FPC 13A5. Furthermore, the FPC can provide the control and data signals to gate driver ICs by the same method provided there is enough space on the display panel.

What is claimed is:

1. A wiring on array (WOA) panel architecture, comprising:
a display panel;
a plurality of source driver integrated circuits (ICs) mounted on the display panel;
a first integrated chip mounted on the display panel, performing the functions of source driver and timing controller and providing first control and data signals to at least one of the source driver ICs;
a printed circuit board (PCB);
a flexible printed circuit board (FPC) connecting the display panel to the PCB; and
a DC-to-DC converter IC mounted on the PCB providing power to the source driver ICs and the first integrated chip through the FPC.

2. The WOA panel architecture of claim 1, further comprising:
a second integrated chip mounted on the display panel, performing the functions of source driver and timing controller, and providing second control and data signals to at least one of the source driver ICs, wherein the first and the second integrated chips receive third control and data signals through the FPC.

3. The WOA panel architecture of claim 2, further comprising:
a gamma operational amplifier IC mounted on the PCB providing gamma reference voltage signals to the source driver ICs and to the first integrated chip through the FPC.

4. The WOA panel architecture of claim 1, wherein each of the source driver ICs further integrates a timing controller IC.

5. The WOA panel architecture of claim 4, further comprising:
a second integrated chip mounted on the display panel, performing the functions of source driver and timing controller, providing second control and data signals to at least one of the source driver ICs, wherein the first and the second integrated chips receive third control and data signals through the FPC.

6. The WOA panel architecture of claim 5, further comprising:
a gamma operational amplifier IC mounted on the PCB providing gamma reference voltage signals to the source driver ICs and to the first integrated chip through the FPC.

7. The WOA panel architecture of claim 4, wherein the first integrated chip and each of the source driver ICs integrates a gamma operational amplifier IC.

8. The WOA panel architecture of claim 7, further comprising:
a second integrated chip mounted on the display panel, performing the functions of source driver, timing controller and gamma operational amplifier, providing second control and data signals to at least one of the source driver ICs, wherein the first and the second integrated chips receive third control and data signals through the FPC.

9. A wiring on array (WOA) panel architecture, comprising:
a display panel;
a plurality of source driver integrated circuits (ICs) mounted on the display panel;
a first integrated chip mounted on the display panel, performing the functions of source driver, timing controller, gamma operational amplifier, and DC-to-DC converter, and providing first control and data signals and power to at least one of the source driver ICs;
a printed circuit board (PCB); and
a flexible printed circuit board (FPC) coupled to the display panel to transmit second control and data signals to the integrated chip.

10. The WOA panel architecture of claim 9, wherein each of the source driver ICs integrates a gamma operational amplifier IC, a timing controller IC, and a DC-to-DC converter IC.

11. The WOA panel architecture of claim 10, further comprising:
a second integrated chip mounted on the display panel, performing the functions of source driver, timing controller, gamma operational amplifier and DC-to-DC converter, and providing third control and data signals and power to at least one of the source driver ICs, wherein the first and the second integrated chips receive the second control and data signals through the FPC.

12. A wiring on array (WOA) panel architecture, comprising:
a display panel;
a flexible printed circuit board (FPC) coupled to the display panel;
a plurality of source driver integrated circuits (ICs) mounted on the display panel;
a timing controller IC mounted on the display panel receiving first control and data signals through the FPC and providing second control and data signals to at least one of the source driver ICs;
a DC-to-DC converter IC providing power to the source driver ICs; and
a gamma operational amplifier IC providing gamma reference voltage signals to the source driver ICs.

13. The WOA panel architecture of claim 10, wherein the DC-to-DC converter IC is mounted on a printed circuit board (PCB).

14. The WOA panel architecture of claim 10, wherein the DC-to-DC converter IC and the gamma operational amplifier IC are mounted on the display panel.

15. A wiring on array (WOA) panel architecture, comprising:
a display panel;
a plurality of source driver integrated circuits (ICs) mounted on the display panel, wherein each of the source driver ICs integrates a timing controller IC, a gamma operational amplifier IC, and a DC-to-DC converter IC;
a first integrated chip mounted on the display panel, performing the functions of source driver, timing controller, gamma operational amplifier, and DC-to-DC converter, and providing first control and data signals and power to at least one of the source driver ICs;
a flexible printed circuit board (FPC) coupled to the display panel to transmit second control and data signals to the first integrated chip.

16. The WOA panel architecture of claim 15, further comprising:
a second integrated chip mounted on the display panel, performing the functions of source driver, timing controller, gamma operational amplifier, and DC-to-DC converter, and providing third control and data signals and power to at least one of the source driver ICs, wherein the first and the second integrated chips receive the second control and data signals through the FPC.
